(19) United States
(12) Patent Application Publication
(10) Pub. No.: US 2017/0139939 A1
(43) Pub. Date: May 18, 2017

(54) METHOD OF SUGGESTION OF CONTENT RETRIEVED FROM A SET OF INFORMATION SOURCES

(71) Applicant: SCOOP IT, LABEGE (FR)

(72) Inventor: MARC ROUGIER, LABEGE (FR)

(21) Appl. No.: 15/353,651

(22) Filed: Nov. 16, 2016

(30) Foreign Application Priority Data
Nov. 16, 2015 (FR) 15 61003

(51) Int. Cl. G06F 17/30; G06N 99/00

(52) U.S. Cl. CPC G06F 17/3097; G06F 17/3053; G06N 99/005

(57) ABSTRACT

A method of suggestion of content retrieved from a set of information sources. At least one content is extracted from information sources based on keywords determined by a curator user and improved by keywords suggested by a suggestion engine. The content to be published is selected. The parameters of the suggestion engine is updated based on user reactions relative to the published content.

### TECHNICAL FIELD

The present invention pertains to the field of information processing techniques and particularly search engines.

It involves more particularly a method of suggestion of content retrieved from a set of information sources.

### PRIOR ART

The extraction of data from a very large volume of data is generally known as “big data”. It involves, for example, the searching for information regarding a predetermined subject.

When the data is press articles, and the goal is to group such articles around a given theme, for example, in order to present them for reading to a public interested in this field, one speaks of a content curation.

Every day, millions of new internet pages are published, regarding countless subjects. The reading of all these pages is naturally impossible for a human reader who is interested in a given particular subject, covered directly or indirectly by certain of the new pages published, by means of text, photos, tables, etc. The need for content curation, that is, an intelligent data compilation interface between the web and the readers, is therefore obvious.

Data curation presents several problems, in particular, the speed of execution, the quality of the results selected, the presentation of these results so that the readers can find them easily in the midst of background noise of new pages published, and so on.

### EXPLANATION OF THE INVENTION

The present invention intends to solve certain of the aforementioned problems. In particular, it deals with a method of content curation that is more efficient in terms of relevance of the content suggestions.

Advantageously, the method is likewise more effective in terms of visibility of the content kept on previously chosen publication sites.

According to a first aspect, the invention deals with a method of suggestion of content retrieved from a set of information sources.

The method involves the following steps:
301 determination, by a curator user, of keywords and/or sources to be used for searching, thus defining search criterions of the user,
302 improvement of search criterions with keywords and/or sources suggested by a suggestion engine, thus defining a search strategy,
extraction of at least one content from the sources of the search strategy based on the keywords of the search strategy,
sorting of the contents according to a distance in relation to the search criterions of the user,
displaying of the sorted contents to the curator user,
303 selection by the curator user of one or more contents evaluated as pertinent,
304 publication of selected contents to reader users,
305 recording the reactions of curator users and of reader users for each published contents,
306 automatic modification of the parameters of the suggestion engine according to recorded reactions, thus creating a feedback and learning loop of said suggestion engine.

In this way, the suggestion engine is automatically upgraded by the actions of the curator users and/or of the reader users in regards one or more content. The suggestions proposed by the suggestion engine are thus improved and more pertinent, which facilitates the task of curation of the curator users.

In one particular embodiment, the method likewise involves a step 308 of determination of one or more publication sites, and publication dates, according to previously determined criteria of maximization of the visibility of the publication so performed.

In one particular embodiment, the method involves:
a step 406 of calculation of a number of views for each page viewed by one, some, or all of the curator users and reader users,
a step 410 of calculation of a score for each content, according to the number of pages viewed and according to the type of action performed by a user on this content: follow 407, share 408, recommend 409,
a step 411 of analysis of the scores for recommending and categorizing the contents in view of their qualification by the users.

In one particular embodiment, the categorization is done by using at least one automatic machine-learning algorithm.

In one particular embodiment, the suggestion engine implements:

a step 502 in which the key words chosen in step 301 are used to browse fields of data in order to extract URL addresses of pages relevant in regard to these key words,

a step 501 in which the system retrieves the content of the web pages selected and stores them in memory,

a step 503 in which the system extracts from these web pages the texts, images and any associated RSS feed addresses,

a step 504 in which these RSS feeds are stored and go into filling a database,

a step 506 of browsing in a loop the URLs of RSS feeds to find the RSS URLs corresponding to the predefined key words,

a step 507 of uploading of these RSS feeds,

a step 514 in which, based on the texts, images and RSS feeds extracted during step 503, the system indexes and stores elements of suggestions, these suggestions being used to fill up a database of suggestions,

a step 516 in which the system performs a search for key words selected by the user in the database of suggestions,

a step 517 of filtering of the data extracted by this search to eliminate the pages already viewed by the curator user during a present search,

a step 518 of application of other filters previously defined by said user,

a step 519 in which the suggestions are sorted by predefined criteria.

In one particular embodiment, in step 308, the system is based on the totality of data already existing both on the level of the user and that of the totality of curator users and/or reader users to determine for each triplet of audience/theme/publication network a set of publication times and intervals considered as being the most effective according to a predetermined criterion.

In one particular embodiment, the method furthermore comprises a step in which the system extracts, for each article shared, the number of responses which it generates, calculates a score for each sharing, and deduces from this the times most favorable to the sharing on each of the social networks.

In one particular embodiment, the method involves a step 605 in which the details of each sharing (date, time, content, destination etc.) are stored, and a step 606 in which the system analyzes the impact obtained by the sharing done, so as to fill up a database for a machine learning.

In one particular embodiment, the step 306 implements an algorithm based on the behavior and the actions of the totality of curator users and/or reader users, making it possible to highlight contents, categorize them in theme groups, and relate them to users having the same centers of interest.

In one particular embodiment, the method involves:

a step 409 of recording of the actions of each reader user: reading of a content, sharing of a content, qualification of a content, or recommendation of a content, in a way tied to said content in order to qualify it,

a step 410 of calculating a score for the content, on the basis of these qualification elements gathered over the course of time,

a step 411 of comparison of the score to predefined threshold values,

i) if this score of the content is less than a first predetermined threshold value but greater than a second predetermined threshold value, a step 703 of calculation of relevant categories for the content, a step 704 of proposing to the user that the user himself make the choice of a category, this choice of the reader user being used in a step 705 to improve the automatic category choice engine,

a step 706 of using the content for recommendations,

ii) if this score of the content is higher than the first threshold value, the content is used for recommendations, and if it has no categories linked to the content, the system as previously calculates categories which will qualify it.

### PRESENTATION OF THE FIGURES

The characteristics and advantages of the invention will be better appreciated by virtue of the following specification, which explains the characteristics of the invention through a non-limiting sample application.

The specification is based on the enclosed figures, which show:

FIG. 1: a diagram of the elements involved in the device,

FIG. 2: a schematic illustration of the operating environment of the proposed system,

FIG. 3: a simplified flow chart of the basic steps of the method of curation,

FIG. 4: a flow chart of the steps of the reading operation,

FIG. 5: a flow chart of the steps of the method of optimized suggestion of contents,

FIG. 6: a flow chart of the steps of the method of sharing of information and planning of publications,

FIG. 7: a flow chart of the steps of the method of recommendation and classification.

### DETAILED DESCRIPTION OF ONE EMBODIMENT OF THE INVENTION

The invention is intended to be implemented by software.

As shown schematically in FIG. 1, the method is implemented by one or more curator users 101 and reader users 106. Each of these curator users 101 and reader users 106 works on a computer 102, for example but not restricted to a PC type. Each computer has means of implementing a portion of the method.

Each computer 102 is linked, via a network 103 known in itself, to various databases 104, as well as to at least one central server 105 on which a software is implemented which carries out another portion of the method.

The function of the curator user 101 is to sort data and select the data that is adapted to correctly describe a predetermined subject, corresponding to the current definition of the subject curation. These curator users 101 can be humans or algorithms. In the case when these curator users 101 are algorithms, one defines a distance between the subject chosen and the data associated with this subject.

The method of “web curation” involves software (Web for example, but not limited to this) making it possible to suggest contents to the users as a function of their interests, previously defined in particular by various key words and stored in memory. The purpose is to extract the essence of these contents and to recommend the most relevant ones as a function of contents already accepted, that is, integrated within topics of various curator users 101. The essence of a document designates here that data which is particularly relevant for characterizing that document: for example, title and subtitles or section headings, key words, author, date, photo, most frequently used words, etc.

In the rest of this description, content is defined as a page of data of web page type, typically containing texts, images, updating time stamps, associated keywords, etc. It could be emphasized that contents should be understood as a plurality of content.

Topic is defined as a set of relevant data, for example, in the form of web pages, images, texts etc., of a same semantic field chosen by a user.

Visibility is defined as the number of times that Internet surfers will come to see a given topic.

The purpose of the system is for the curator user 101 to augment the visibility of his topics on the web for reader users 106, by positioning himself thanks to the system as a specialist in a very particular field. Reader user 106 defines a user who will come to read the content of various topics that interest him.

With this goal, the system makes it possible to disseminate a selected content on the web along several lines: visibility on search engines, social networks, enterprise sites of users, etc.

The system makes it possible to preserve the selection made in the body of a magazine, regrouping all of the relevant contents on a single public page.

The system proposes on-line tools for “content marketing”: a marketing strategy that involves the creation and the dissemination, by an enterprise, of media contents in order to acquire new clients.

### Operating Environment of the System (FIG. 2)

The heart of the system is a platform (defined as a set of services) which represents, that is contains, the references of a very large number of Internet page addresses. As an order of magnitude, in no way limited to this, the platform here represents more than 50 million URLs. It involves a system of curation of editorial contents and a community platform with a large audience.

The architecture of the platform is based on the web architecture illustrated in FIG. 2. As seen in this figure, the method is used in the context of a data network of Internet type 201. The system implements: a module 202 for protection against denial of service attacks, a module 203 for load balancing (“IP load balancing” and “http load balancing”) among users.

It furthermore comprises on the one hand at least one web navigation (“crawling”) server 204, at least one page suggestion server 205, associated with a “big data” system 206 of storage of Internet pages, that is, a database storing a very large volume of Internet pages.

The suggestion servers 205 and the protections 202 and load balancing modules 203 feed at least one application server 207 associated with an image server 208. The application server 207 implements a search engine 209.

Furthermore, the image server 208 is connected to a big data database 210 for storage of images and a relational storage database 211. References to the images are stored in a relational database in order to allow joins between the noSQL systems and the relational storages.

The application server 207 and the image server 208 are linked to a cache database 212. The application server 207 is connected to an event storage database 214. This event storage system can be viewed as a log system which can be used for maintenance operations, or for internal or external statistics (external=for the users). In addition to the application servers 207, a cluster of NoSQL servers 213 is used to store the nonstructured data and execute various algorithms of recommendation, classification, statistical analysis and other operations on this data.

Finally, the event storage database 214 feeds at least one asynchronous task calculation server 215, calculation tasks to provide statistics to the user but also for internal needs which will also supply the results of these calculations to the non SQL storage database 213.

The exploration of the web and the gathering of meaningful data on the web pages is based on programs (written for example in Python—registered mark—and in Java—registered mark), which make it possible to browse and extract the essential information from the pages visited.

All or part of the functions of 201 Internet access, 202 protection, 203 load balancing, navigation servers 204, suggestion servers 205, 206 storage of Internet pages, application servers 207, image servers 208, search engine 209, database management 210, 211, 212, 213, 214, and asynchronous calculation servers 215 are executed by a central server 105 of FIG. 1.

### General Functioning of the Curation Method (FIG. 3)

The suggestions proposed by the system implementing the method come from key words and sources selected by a curator user 101.

Suggestion is defined as an Internet page address containing information relevant to a previously chosen theme, the latter being defined for example by a set of key words.

Source is defined as the address of an Internet data server or page, for example but not limited to being independent of the present system.

In the present example of implementation, the method uses a very large portion, even all of the data (that is, pages, texts, images) stored or referenced by the other curator users 101 and reader users 106 to qualify, arrange, and filter the content suggested.

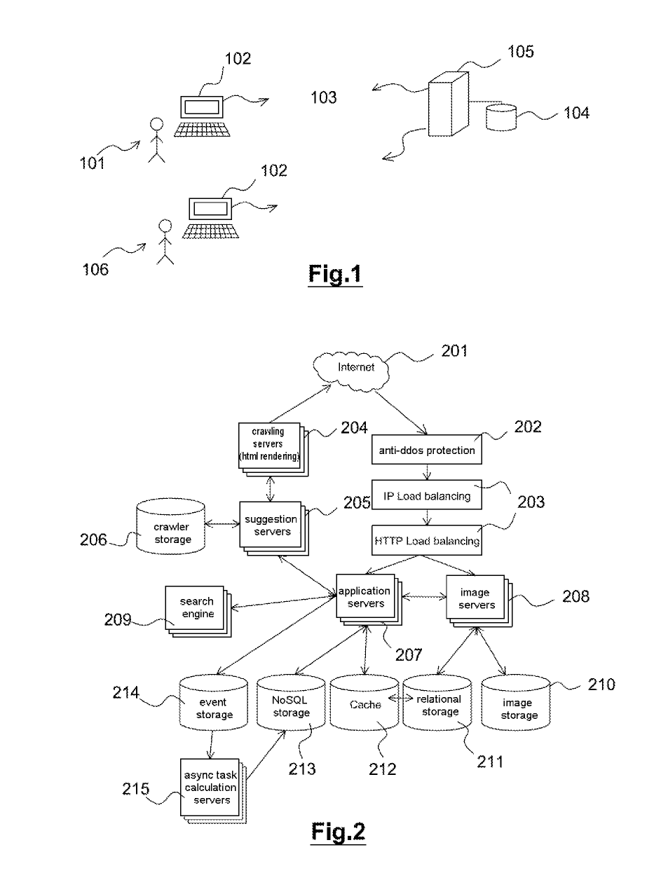

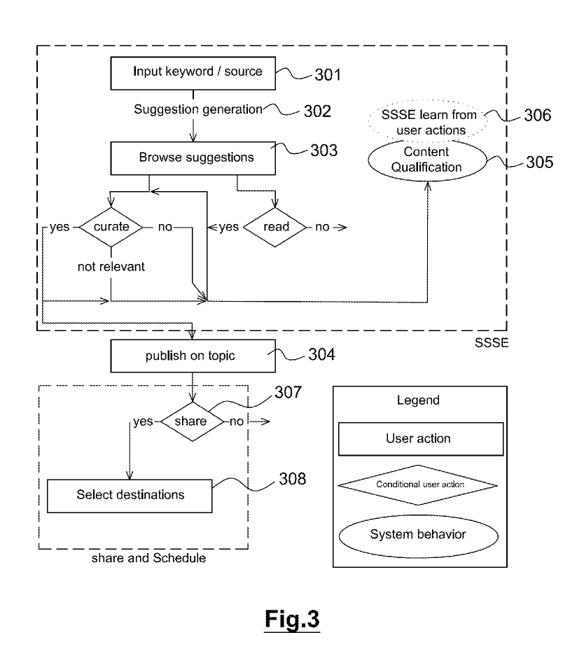

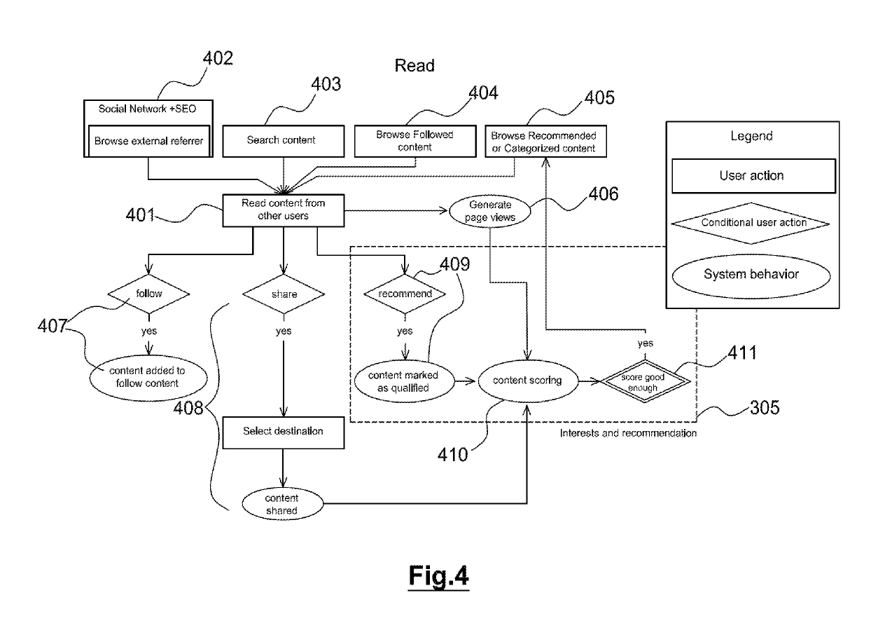

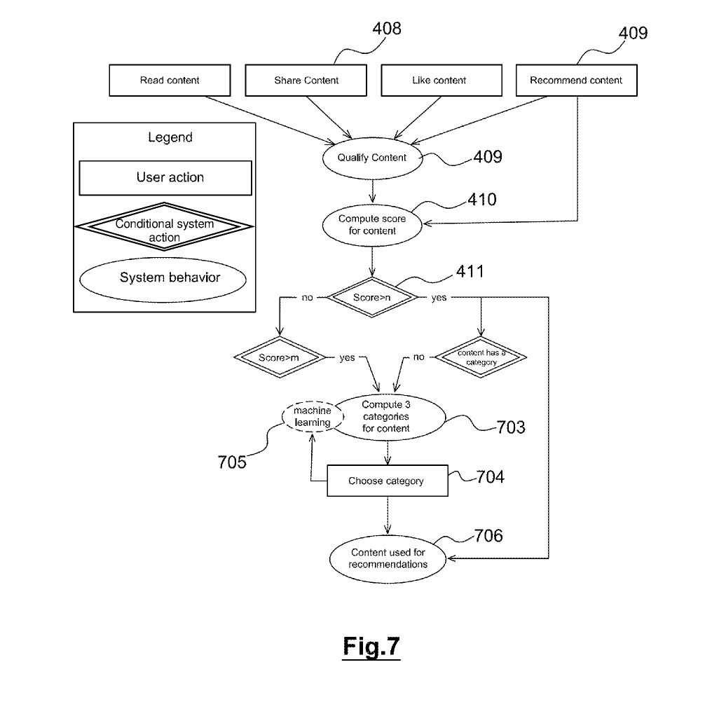

The suggestions sent to a curator user 101 come both from key words and sources given by this curator user 101, but also from all of the knowledge acquired by the system through analysis of the behavior of the other curator users 101 and reader users 106 of the contents (see FIGS. 4 and 7 and the associated descriptions).

FIG. 3 illustrates this functioning. In a step 301, a curator user 101 determines key words regarding a predetermined subject, or sources to be used for the response to a search, and enters this data in the system implementing the method of the present invention. The keywords and the sources determined by the curator user 101 defines this way search criteria of the curator user.

In a step 302, a suggestion engine (hereinafter called “suggestion engine 302”), implemented here in a non-limiting example by a central server, update one or more the search criteria with keywords and/or sources suggested by the suggestion engine 302, defining this way a search strategy.

It could be emphasized that the parameters of the suggestion engine 302 are specific to each curator user 101. In another words, there is preferentially a separate suggestion engine 302 for each curator user 101.

During this step 302, the suggestion engine performs also a sorting of the data (information, articles) to which it can gain access, and determines for this data a distance in regard to an ideal response to the search criteria of the curator user. It then sends to the curator user 101 the most relevant data (articles), classed for example by increasing distance from the ideal response.

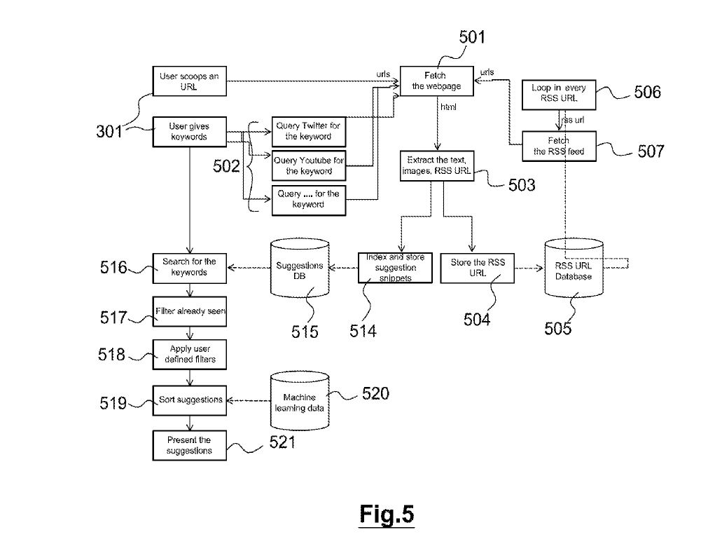

The details of step 302 are given in FIG. 5.

In a step 303, the curator user 101 analyzes this data (comprising for example various Internet pages) and determines, for each data item, in a step 310, whether it should be browsed and analyzed in more detailed manner (“Read”). If this is not the case, the curator user 101 moves on to the next suggestion. If it is the case, the suggestion is browsed in detail (“read”), then evaluated in a step 309 to determine whether it corresponds to a predetermined criterion and should therefore be published (“curate”) in regard to the initial search, this predetermined criterion possibly taking into account the date of the data item or its source, for example.

If the data corresponds to the predetermined criterion of relevance, in a step 304 the data is characterized as being publishable in a folder pertaining to the subject initially chosen.

Whatever the classification of the data in regard to the criterion of relevance given by the curator user 101 in step 310 (to publish, not to publish, not relevant), in a step 305 the data is associated with a qualification characterizing its relevance in regard to the initial search, or by supplementing its description with various key words or quality notes.

In a step 306, these supplemental elements for qualification of the data in regard to the initial search are used to modify the setup parameters of the suggestion engine, thus creating a feedback and learning loop of said suggestion engine.

In a step 307, the system determines whether the data should be shared or not.

If the data should be published, in a step 308 the system determines one or more publication sites, and publication dates, according to previously determined criteria of maximum impact of the publication so performed.

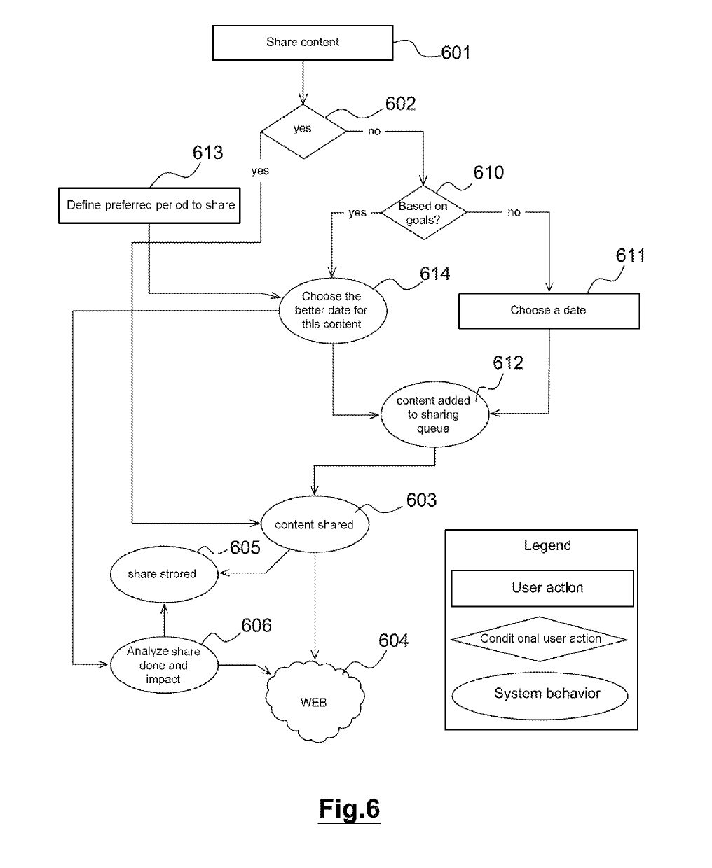

The details of step 307 are given in FIG. 6.

In order to be able to provide the curator user 101 with a large number of suggestions of relevant contents in regard to his working theme, the system implementing the method of curation described here should be able to discover in real time the largest possible proportion of articles corresponding to the interests of a user. In fact, it is not enough to provide content of quality, one must furthermore provide it in real time or as close as possible to that state. Thus, an issue of speed of collection of new information and extraction of the useful portion arises. In fact, the system needs to refine the qualification of an article and extract from it the information that is useful to its qualification. The uncertainty in this regard lies in the selection of the necessary information for the qualification of the article.

For reasons of readability of the suggestions by the curator user 101, the system should be able to extract the essence of the article, defined here as an image associated with the article, as well as a significant text excerpt for the comprehension of the article.

The system of information collection does not collect the entire web, but only a portion thereof corresponding to the subject treated by the users of the platform. However, the primary limitation lies in the fact of being able to extract the parts necessary for the later proper analysis of the content.

The idea is to provide the users of the system with a maximum number of relevant articles (and their associated data) captured on the Web in real time. Thus, it is also a question of extracting the related semantic information on pages whose structure varies from one site to another. The system must find a solution that is generic (substantial diversity of data) and rapid (proposing articles to the users in real time).

Two known techniques exist for finding a maximum content. The first is the recursive data exploration/extraction technique that consists in tracking down from one link to another all of the documents present on the web. The second technique is to utilize and multiply the outside services (in order to benefit from work already done) in order to extract only the content which is of interest a priori, while guaranteeing a sufficient speed of execution.

For the extraction of data from documents, solutions or tools exist which only implement a portion of the needs for the exploration of web documents (exhaustive web exploration) and incomplete frameworks (set of software components) of exploration and semantization for the web. In fact, the system must be able to preselect a subset of the web before exploring it, since exploring the entire web would be much too costly in terms of resources and infrastructure.

The inventors have thus decided to develop their own solution, of an iterative procedure, so as to be as simple and rapid as possible, while still remaining relevant.

Several methods for data collection can be contemplated. The algorithms implemented in the method concentrate on a restricted perimeter of the web. The system limits the exploration of the web to the fields of interest as declared by the curator user 101 through key words. These key words make it possible to select, via different APIs, the URLs that are the starting points of a search for contents on the web.

Moreover, the system accumulates a lot of RSS feeds which can also serve as a framework for the exploration of the web.

In fact, these RSS feeds have been entered by the group of the curator users 101 and reader users 106 and thus the subset of the web which they represent is a reflection of relevant contents for the curator users 101 and reader users 106.

The extraction of the content of essential data and pages for the qualification of the contents has undergone several implementations:
Simple reading of HTML meta-data,
Displaying of pages visually in a pseudo navigator (PYTHON® and QTWEBKIT®—registered marks) to find the primary information. The rendering of web pages via QTWEBKIT®—registered mark—makes it possible to produce a rendering of the page and thus extract the content based on evolutive visual rules.

These techniques have the drawbacks of poverty of content extracted or resources needed for their implementation.

The extraction of data here is based on an analysis of microformat data (fr.wikipedia.org/wiki/Microformat) and in particular the OpenGraph protocol (ogp.me/).

However, certain information is not available or certain web pages do not provide this information. What is more, the information extracted is not sufficient.

It is thus desirable to put in place new algorithms to extract the entire content of an article. The algorithm is based primarily on heuristics for the meta-data and the structure of the web page. The system uses a list of HTML elements and CSS classes that are often used to delimit the article in the web page. Thus, the algorithm locates all the contents framed by these elements and these classes. Within this list of contents found, the method implements other heuristics to locate the principal article. For example, the method assigns importance to the size of the content found, and the place of this content in the structure of the HTML document.

Based on a list of popular web sites, the method automatically ensures that the algorithm is able to extract the content in sufficient quantity, that is, greater than a predetermined value.

To identify the impact on the social networks of the pages analyzed, various social networks are polled for each of the pages in order to determine the number of “likes”, “tweets”, etc. of an article.

### Reading Operation (FIG. 4)

Once the contents have been extracted during the curation phase, they are published in the topics of the curator users 101, and thus made available to the reader users 106, according to their focus of interest.

In the present non-limiting example of the implementing of the method, a reader user 106 discovers in a step 401 Internet content from several sources (top of the diagram in FIG. 4). These sources of contents: social networks 402, search engine 403, “followed content” 404, recommendation or categorization 405, etc., make it possible to discover publishable content for the user in regard to his working theme. These viewed contents make it possible to calculate, in a step 406, a number of views for each page viewed by one, some, or all the curator users 101 and reader users 106.

The reader user 106 can perform several actions on these contents: follow 407, share 408 (in this case at least one sharing destination is selected by the user), recommend 409 (in this case, the content is marked as being qualified). These actions associated with the pages viewed that are calculated in step 406 make it possible to calculate a score for each content (step 410). Each of these actions gives value to the content for which the action is performed. These notations associated with algorithms make it possible to calculate a score for each content.

This score is then analyzed by the system in a step 411 to recommend and categorize the contents for their browsing by the reader users 106 in step 405. The categorization is partly based on automatic machine learning algorithms. The reader user 106 furthermore validates the choice of the category. This validation then serves as input for the machine learning algorithms.

The details of steps 409, 410 and 411, supplementing step 305 of FIG. 3, are given in FIG. 7 with regard to the interests and recommendations.

### Operation of the Suggestion Engine (FIG. 5)

The information gathered on the Internet as well as the information selected by the curator users 101 needs to be filtered and classed, in order to then be highlighted on the pages of the system.

Thus, the articles gathered on the Internet need to be analyzed, classed, and filtered, in order to then be proposed to the curator users 101. In fact, the first level of curation is done by the suggestion engine 302 which needs to be able to select, from among all of the articles extracted on a daily basis from the Internet, those which need to be proposed to a given curator user 101.

For this, several systems need to be put in place: analysis of data, classification and filtering before proposing these contents to the curator user 101. The time for execution of the calculations needs to be fast in order to allow a proposing of new content several times a day.

In a first version, the suggestion engine 302 calls for web APIs to find contents for proposing to the curator user 101. No pooling of global information (that is, information coming from all the users) of the platform is utilized.

In a second version utilizing algorithms for recommendation and classification of the content, the experience gained makes it possible to qualify, filter and rank the information gathered on the web.

Given the particular nature of the content of the platform, which is essentially comprised of citations of articles pre-existing on the web, the system deals with the recommendation of short content.

The platform of the system offers functionalities of social interaction, so that algorithms taking advantage of the social aspect of the data meet the needs of the system. Special attention to the volume of data is necessary in accordance with the evolution of the system. The scalability of the algorithms is important, that is, their ability to accommodate a data volume which may greatly increase over the course of time.

The system carries out an implementation of a collaborative filter algorithm via a search engine. All of the contents collected via the suggestion engine 302 are stored in a “big data” system (an English term designating data groupings that are so large that they become hard to work with using classical database management or information management tools—source Wikipedia). This data is then indexed and augmented with internal or external meta-data. This index then allows a proposing to the users of the data so collected without going through the web APIs. Thus, the curation method described here as a non-limiting example enriches over the course of time its own databases of noncurated contents of possible use to future curator users 101.

Hence, in addition to data analysis algorithms, it is necessary to filter and sort the contents so as not to present contents of little interest and to display the contents in the best possible order for the curator user 101. The curator user 101 enters key words in order that the system can propose content to him, and so the first means of filtering is based on these key words. Since the system proposes content to the curator users 101 who then have the choice to select whether to publish or reject it, it is possible, in a later step, to learn the behavior of the curator users 101 so as to classify and filter the content.

The suggestion engine 302 is directly dependent on the portion pertaining to the collection of data on the web. Hence, the issues revolve around the volume of data extracted. If the latter is not large enough, the suggestion engine 302 lacks data to be analyzed, sorted and organized. On the other hand, the collecting of data should extract the important data in order for the algorithms of analysis, sorting, and organization to work. The quantity of data contemplated at present is 25 million pages analyzed a day, and this appears to be ideal for the algorithms.

The purpose of the suggestion engine 302 is to profit from all of the articles extracted from the web, according to various predetermined criteria or key words, in order to propose them to the curator users 101. Toward this end, in a step 501 (see FIG. 5) contents in the form of URL addresses are retrieved to the server 102 by sources of contents associated with the key words entered by the curator user 101 (in step 301). The objective is to then sort, filter and organize them.

The suggestion engine 302 carries out an algorithm which uses, as the first sorting, the number of key words detected in the suggestions. If two suggestions have the same number of key words, the secondary sorting used is the publication date of the content. This algorithm thus combines relevance and freshness of the content. It also makes it possible to render the sorting comprehensible to the users, since all the criteria used are displayed.

Certain data of the web articles is crucial during the extraction of content in order to enable a good qualification of that content thereafter. This data is then the working basis of algorithms making it possible to class, sort, and filter the contents. Within this data, several items of information are searched: the dates of the articles, the author, the illustration image, etc. As for the date of the articles, this information is sometimes not present or it is hidden within the content itself.

The social popularity of the articles is, furthermore, one of the best indicators of the quality of an article, but it is also hard to obtain. This type of metric is the property of the different social networks, and the polling of these social networks in an intensive manner (30 million/day) requires a substantial architecture.

As illustrated in non-limiting manner in FIG. 5, the suggestion engine 302 carries out a set of algorithms capable of choosing, classing, and qualifying contents to be proposed to the curator user 101. These algorithms are based on the totality of knowledge as to the behavior of the curator users 101 and on the totality of the content that the system possesses or is able to search for on the web. They also utilize the key words entered by the curator users 101.

As has been seen, in a step 301 the curator user 101 determines key words and/or sources in the form of URLs. In a step 502, the key words chosen are used to browse data domains of Twitter (registered mark), Facebook (registered mark), and other type so as to extract URL addresses of relevant pages in regard to these key words. In step 501, the system retrieves the content of the selected web pages and stores it in memory.

In a following step 503, the system extracts from these web pages the texts, images and any associated RSS feed addresses.

In a step 504, the RSS feeds are stored and go into filling a database 505. In a step 506, the system browses in a loop the RSS feed URLs to find the RSS URLs corresponding to the predefined key words. These RSS feeds are then uploaded in a step 507.

Using the texts, images and RSS feeds extracted during step 503, in a step 514 the system indexes and stores the suggestion elements (snippets). These suggestions will go into filling up a database 515 of suggestions in the form of URLs associated with the key words of the search. The storage consists in storing a URL associated with a set of data extracted from the page: date, title, useful content (purged of ornaments), essential images of the page, etc., as well as meta-data helping in the qualification (key words, etc.).

In a step 516, the system performs a search for key words selected by the user in the database 515 of suggestions containing all the preceding suggestions for all the users of the database.

The data extracted by this search is filtered to eliminate the pages already viewed by the user during the present search (step 517), and to apply other filters previously defined by said user (step 518).

In a step 519, the suggestions are sorted by predefined criteria, for example, by associated date, or by a more complex criterion of a quality score or the like. These score criteria may come from machine learning data saved in a database 520.

Finally, in step 521, the system presents the suggestions found, filtered and sorted to the user in response to his request.

### Example of Evaluation of a Distance of a Content Relative to an Ideal Response

The distance relative to an ideal response of a search based on search criterions of the user is evaluated with static and dynamic criterions. A given criterion is considered as static if it is invariable in time and independent of a curator user.

The first static criterion allowing the evaluation of the distance relative to an ideal answer is a function of the positioning of the keywords determined by the curator user 101 in a content extracted by the suggestion engine 302. The evaluation of this positioning corresponds to the position of the keywords in the title, in the body of the page, in the URL of the page or in a comment of the page. In other words, the evaluation of the positioning of the keywords in the content allows estimation of the relevance of the contents relative to the keywords.

Another static discriminating criterion is the language of the content, which is automatically determined through an algorithm. The language of the content has to—or at least preferentially—corresponds to the language of the curator user.

The quality of the suggested contents is another static criterion. The quality is estimated according to the volume of the contents, the diversity of the vocabulary, the size and the quantity of associated illustrations. It could be emphasized that the evaluation of the quality of the content is estimated by an algorithm updated by adaptive learning based on the user actions.

The popularity of the content via the social networks is a considered criterion. This criterion evolves in time, but is not a function of the curator user 101.

All the curator users 101 of the platform bring, by their interaction with their respective suggestion engines 302 individual, information on each extracted contents. This information is correlations between the acceptance of the suggested content, and the intrinsic quality of this content. This correlation corresponds to a dynamic criterion taken into account in the evaluation of the distance relative to an ideal response.

Finally, the interactions of a curator user with his suggestion engine 302, allows a closeness to be established between the topic covered by the curator user 101 and the topic of the suggested content. This criterion evolves in time and is individually calculated for each curator user 101.

### Operation of the Module for Sharing and the Module for Optimized Scheduling of Display (See FIG. 6)

The curator users 101 of the system want their ecosystem, defined as being the totality of reader users 106 of web pages who regularly follow their publications, referencing, responses on the social networks, to profit as best as possible from the articles which have been selected. Thus, the mere publication on a page of the system is not sufficient.

The objective is to share these articles on the various social networks. However, sharing on random time intervals is not efficient, for example in terms of number of pages viewed. The objective of the system is thus to share the documents selected in time slots automatically adapted to the audience of the curator user 101. To do so, the system (in step 308 given above) must be based on the totality of data already existing both at the level of the curator user 101 and that of the totality of users in order to determine, for each triplet of audience/theme/social network of publication, a set of publication times and intervals considered as being the most effective according to a predetermined criterion, for example, by using the number of pages viewed.

The goal is thus to construct algorithms to realize a system capable of automatically selecting the best times for sharing a content as a function of the audience of the user, the themes of the user, and the social network in question. Certain time slots are commonly considered to be better than others in terms of social networks. To pin down the best time for sharing, it is proposed to include the responses generated on a given social network, and to make suggestions of time slots to the curator users 101.

In one variant, the system repeats several times the same information on each of the social networks. This repetition is not random, but rather based on analysis of the results of the sharing. This method makes it possible to reach more people, even though the large mass of information on the social networks does not allow the reader to review all of the information streams constantly.

A first challenge is the ability of the system to find out about the “responses” generated by the sharing of the users in order to then determine the best time slots for each user.

A second challenge is to establish rules as a function of content themes (categories).

The objective is first of all to manage preferred scheduling times for the sharing on the social networks. These preferred times are generated in static manner, and can be afterwards modified for each of the pairs of curator user 101/topic.

In the embodiment described here, preferential times for each social network are determined in advance, and the sharing is done as a priority at these preferential times according to the time zone as defined by the administrator of the topic.

Then the next step is to extract for each article shared the number of responses generated. To do this, the APIs of the different social networks are used.

It is likewise possible to use the number of views for the article based on the “referer” of the navigator of the user 101. It is thus possible to calculate a score for each sharing (for example, calculated as being the number of responses on social networks plus the number of views). This score then represents the success of a sharing. By making calculations for the success average per hour, it is possible to define the most favorable hours for the sharing on each of the social networks.

Armed with the knowledge of the amplification of the sharing on the social networks thanks to the analysis of the sharing performed from the system and the objectives set by the users, the module for optimization of the posting schedule allows the curator user 101 to share these contents at the optimal time for them to receive the best possible impact on the social networks.

FIG. 6 details the operation of the module for sharing and the module for optimization of the posting schedule.

As can be seen in this figure, in a step 601 when the curator user 101 decides to share a content, he is asked in a step 602 if he wants an immediate sharing or not.

If he wants an immediate sharing, the content is shared in a step 603 and published on the web (step 604). At the same time, the details of this sharing (date, time, content, destination, etc.) are stored in a step 605, and in a step 606 the system analyzes the impact obtained by the sharing done, so as to fill up a database for a machine learning. The resulting impact can be measured by the number of page views or by other parameters (duration of time spent on the page, citations, etc.).

In the event that the curator user 101 does not want an immediate sharing of the content, in a step 610 he chooses a date based on a result objective or not. If he does not want a schedule based on a result objective, in a step 611 he chooses a sharing date, and in a step 612 the content to be shared is added to a queue awaiting its publication on the chosen date.

In the event that the curator user 101 chooses during step 610 a date based on a result objective, a preferred sharing date having been previously defined during a step 613, the system determines in a step 614 the date (or a set of dates) best adapted to the objective of result maximization, and then adds the content to be published to the queue awaiting its publication associated with this sharing date or dates calculated.

### Operation of the Recommendation and Classification System (FIG. 7)

This system, based on the behavior and the actions of the totality of the curator users 101 and reader users 106, makes it possible to highlight contents, categorize them into theme groups, and relate them to the reader users 106 who have the same centers of interest.

FIG. 7 illustrates its operation in detailed manner.

When a given user of the system reads a content, shares a content, or qualifies a content with a “like” tag, the system records in a step 409 these actions of the users, in a way tied to said content in order to qualify it. The system then calculates in a step 410 a score for the content, based on these various evaluation elements gathered over the course of time.

Depending on the result of a step 411 of comparing the score to predefined threshold values, if the score of the content is less than a first predetermined threshold value but greater than a second predetermined threshold value, the system calculates (step 703) three relevant categories for the content and proposes (step 704) to the user that the user himself make the choice of a category, this choice of the user being used in a step 705 to improve the automatic category choice engine. It is clear that the number of categories calculated can be more or less than three in variant embodiments of the present method.

Finally, in a step 706, the content is used for recommendations. In other words, once the content has been categorized, it is posted in a dedicated part of the site in its category with its ranking in regard to the other contents in this section.

If the score of the content is greater than the first threshold value, it is used for recommendations, and if it has no categories linked to it the system as previously calculates, three categories which will qualify it.

If the score of the content is less than the second threshold value, it is not used for content recommendations.

### Storing of Data

The system should be able to store large volumes of data corresponding to the pages indexed during the reading stage.

The objective in terms of number of articles stored is 30 million/day or around 30% of the articles browsed and analyzed. Moreover, for each article the user can choose an image to be associated with it. For this purpose, the system should also be able to store a large number of images and be able to present them very quickly.

In a setting of large volumes, particular attention is given to the ability to read quickly and efficiently the articles for proposal to a user. For the storing of articles extracted from the web, relational databases are not very compatible with an intensive writing of data. Recent years have seen the emergence of non-relational (NoSQL) databases. Certain of these databases are particularly adapted to the intensive writing of data. The system should be able to store more than 30 million articles per day while being able to present these contents in real time to the users. Moreover, it must be able to store them sufficiently efficiently to be able to present them rapidly to the users.

Thus, a problem of competition between reading and writing arises. The system should be able to quickly write a large quantity of information of relatively small size (one article), but also deliver a group of complete articles selected in “batch” mode.

In order to be able to store data efficiently, the system uses SQL and NoSQL storage in parallel.

Many storage systems have been contemplated for the storage of data extracted from the Internet:
SQL database, abandoned because the volume of data is too large,
NoSQL too slow at reading.

The inventors have thus developed a redundant storage system (GPDB—Grabbed Post Data Base) where the writing is done in concatenation to a data file. Each reading request reads entirely one of the data files. This approach makes it possible to enjoy very good writing performance without thereby blocking the reading of the totality of the data in a single request.

The redundancy of this system of storage is assured by synchronization (rsync) of the file system of a master machine to a secondary server. This synchronization is done for example once a day. However, such a replication has many drawbacks in event of loss of the master machine:
the data is only synchronized once a day, so it does not take into account the most recent additions/deletions,
a manual action is required to declare the second server as being the master server.

It is desirable to enable a synchronization of the data in real time. Thus, the inventors have chosen, in the present non-limiting sample embodiment, to opt for a “master-slave” replication. Like MySQL, the master server writes a log file of all the writing actions to be done on the data. The slave server then reads the log file of the master and executes the operations sequentially.

### High Availability of Servers and Software Layers

The software and hardware architecture should be analyzed and improved to meet the challenges of scalability. The high availability of a web service platform depends essentially on the architecture put in place, as well as the ability of the software layers to respond efficiently.

From a perspective of architecture, an LVS cluster is able to ensure a workload distribution. Consequently, it is essential to provide a second level of workload distribution to the application servers. This second layer can be ensured by Apache servers.

From a perspective of application, two factors are paramount in enabling a high application availability. First of all, making the application servers stateless allows one to handle problems of synchronization between application layers, as well as the ability to sustain a stoppage of one of the application machines (maintenance or malfunction). On the other hand, the database often constitutes the single point of failure. It should thus be possible to utilize either master-slave or master master replication techniques, clustering, or even block-to-block replication of the file system hosting the database. Finally, a reduction in download time of the pages can be done in two ways: optimization of requests made, but also via a layer of distributed caches, such as Memcached.

The system aims to achieve an elevated visibility level on the web and a sizeable number of pages delivered (typically 15 million pages viewed per month). The issue is thus to implement software and hardware layers able to absorb peak workload while guaranteeing a constant response time. The inventors have developed a technique of writing to the cache in order to guarantee data integrity.

For this purpose, three types of operations are distinguished which can result in a writing of a resource in the cache:
a reading of the resource from the database
a writing of the resource to the database
a deletion of the resource from the database

Each operation will be assigned a priority. If two writing to cache operations occur “at the same time”, the writing which comes from an operation with the highest priority will prevail. For example, if two servers access the same resource at the same time, one modifying the resource, the other reading it; only the version of the resource coming from its modification will be found in the cache. It is the same for a deletion of a resource: the deletion being definitive, no other placement of the resource in the cache should be possible after the deletion. The system uses a “tomb stone” which is placed in the cache in the location of the resource with the highest priority.

The managing of the competition of write operations in the cache utilizes a classical “Compare-and-Swap” mechanism. Thus, the write operations are guaranteed to be sequential for each resource. The system of priority assigned for the purpose of the writing guarantees the integrity of the data in cache with respect to our transactional model.

### Referencing Optimization

The search engines constantly update their algorithms to adapt to the new Internet practices and improve the relevance of their results, and these algorithms remain secret.

At the level of structure of content, the system utilizes the adding of HTML5 semantic tags in the source code of the pages. These tags <article>, <header>, <nav>, <footer>, etc., allow the search engines to identify more easily the structure of the pages and the contents which are highlighted there.

The de-duplication of the URLs of pages sharing the same URL because they are downloaded in Ajax (for example, during navigations by tabs) will be implemented. The use of the PushState function allows the search engines to distinguish between these pages, and thus increase the number of pages indexed.

### Advantages

The system described above makes it possible to find, suggest and organize the web articles as a function of the interests of the users and to offer the users an increased visibility on the web.

The system is a platform which should be in constant evolution and constantly enriched with new content and it should be constantly able to propose contents which are increasingly closer to the interests of each user, while remaining fast and able to handle the constantly growing audience workload. Moreover, the system makes it possible to position the user as a thought leader in his themes. For this, the system should enable a sharing at the right time on the social networks.

1-12. (canceled)

13. A method of suggestion of content retrieved from a set of information sources, comprising the steps of:
determining by a curator user of at least one of keywords and information sources to be used in searching to define a search criteria of the curator user;
improving said search criteria with at least one of keywords and sources suggested by a suggestion engine to define a search strategy;
extraction of at least one content from the information sources of the search strategy based on the keywords of the search strategy;
sorting said at least one content according to a distance in relation to the search criteria of the curator user;
displaying the sorted contents to the curator user;
selecting by the curator user one or more contents evaluated as pertinent;
publishing the selected contents to reader users;
recording reactions of other curator users and the reader users for each published content; and
automatically modifying parameters of the suggestion engine according to the recorded reactions, thereby creating a feedback and a learning loop of said suggestion engine.

14. The method as claimed in claim 13, further comprising a step of determining one or more publication sites, and publication dates, according to a previously determined criteria of maximizing a visibility of a publication.

15. The method as claimed in claim 13, further comprising the steps of:
calculating a number of views for each page viewed by at least one of the curator users and the reader users;
calculating a score for each content, according to a number of pages viewed and according to a type of action performed by a reader user on said each content, the type of actions being one of the following: follow, share and recommend; and
analyzing the scores to recommend and categorize contents in view of their qualification by at least one of the curator users and the reader users.

16. The method as claimed in claim 15, wherein the contents are categorized using at least one automatic machine learning algorithm.

17. The method as claimed in claim 13, further comprising steps implemented by suggestion engine:
browsing fields of data utilizing the keywords chosen by the curator user to extract URL addresses of pages relevant to the keywords chosen by the curator;
retrieving content of web pages selected by the curator user and storing the retrieved content in a memory;
extracting texts, images and associated RSS feed addresses from the selected web pages;
storing the RSS feed addresses and utilizing the RSS feed addresses to populate a database;
browsing in a loop URLs of RSS feeds to determine RSS URLs corresponding to predefined keywords;
uploading of the RSS feeds;
indexing and storing elements of suggestions based on the extracted texts, the extracted images and the extracted RSS feeds, the suggestions being used to populate a database of suggestions;
searching for the keywords selected by the curator user in the database of suggestions;
filtering data extracted by the search for the keywords selected by the curator user to eliminate pages already viewed by the curator user during a present search;
applying filters previously defined by said curator user; and
sorting the suggestions by a predefined criteria.

18. The method as claimed in claim 14, wherein the step of determining said one or more publication utilizes a totality of already existing data at a level of the curator user and at least one of a plurality curator users and the reader users to determine a set of optimal publication times and intervals in accordance with a predetermined criterion for each triplet of audience, theme and publication network.

19. The method as claimed in claim 18, further comprising steps of extracting, for each article shared, a number of responses which it generates; calculating a score for each sharing; and determining from the score, favorable times for sharing on each social network.

20. The method as claimed in claim 19, further comprising steps of storing details of each sharing, the details comprising at least a date, a time, content, and a destination; and analyzing an impact of sharing to populate a database for a machine learning.

21. The method as claimed in claim 13, wherein the parameters of the suggestion engine are automatically modified based on behaviors and actions of at least a plurality of curator users and the reader users, thereby enabling the suggestion engine to highlight contents, categorize the contents in theme groups, and relate the contents to users having same areas of interest.

22. The method as claimed in claim 21, further comprising steps of:
recording of qualified actions of each reader user, the actions comprising at least one of the following: reading of a content, sharing of a content, qualification of a content, and recommendation of a content;
calculating a score for the content based on the qualified actions gathered over a course of a predetermined time;
comparing the score to predefined threshold values; and
performing following steps in response to a determination that the score of the content is less than a first predetermined threshold value but greater than a second predetermined threshold value or to a determination that the score of the content is higher than the first threshold value and the content has no categories linked to it:
calculating relevant categories for the content by an automatic category choice engine,
request the curator user to select a relevant category,
updating rules of the automatic category choice engine based on the user selection of the relevant category, and
utilizing the content for recommendations.

23. A non-transitory computer program product storing computer executable program code instructions for implementing a method as claimed in claim 13.

24. A computer system of suggestion of contents to execute the non-transitory computer program product as claimed in claim 23.
